(19) United States
(12) Patent Application Publication
(10) Pub. No.: US 2018/0290636 A1
(43) Pub. Date: Oct. 11, 2018

(54) Brake Control Device

(71) Applicant: Hitachi Automotive Systems, Ltd., Hitachinaka-shi, Ibaraki (JP)

(72) Inventors: Yusuke WATANABE, Atsugi-shi, Kanagawa (JP); Toshihiko HIGASHI, Iwata-shi, Shizuoka (JP)

(21) Appl. No.: 15/769,941

(22) PCT Filed: Oct. 4, 2016
(86) PCT No.: PCT/JP2016/079460

§ 371 Date: Apr. 20, 2018

(30) Foreign Application Priority Data
Oct. 21, 2015 (JP) 2015-207111

(51) Int. Cl. B60T 8/1761; F16K 31/06

(52) U.S. Cl. CPC B60T 8/17616; B60T 8/363; F16K 31/0651

(57) ABSTRACT

Provided is a brake control device in which a stable intermediate opening degree can be achieved. The amount of energization for energizing a solenoid of an electromagnetic valve is calculated in accordance with upstream-downstream pressure difference of the electromagnetic valve before the end of hydraulic pressure adjustment of a braking force generator. The valve opening amount of the electromagnetic valve is controlled to fall within an intermediate opening range between the open and closed positions of the electromagnetic valve.

### TECHNICAL FIELD

The invention relates to brake control devices.

### BACKGROUND ART

A Patent Literature 1 discloses a technology for maintaining an electromagnetic valve temporarily in an intermediate opening degree when the valve is closed, for the purpose of preventing the occurrence of oil hammer associated with a sharp fluctuation in flow rate of brake fluid.

### CITATION LIST

### Patent Literature

PTL 1: Japanese Unexamined Patent Application Publication (Kokai) No. 2008-126921

### SUMMARY OF INVENTION

### Technical Problem

According to the above-mentioned conventional art, however, the current which is applied to a solenoid to bring the electromagnetic valve into the intermediate opening degree has a constant value. Consequently, depending on difference between pressures on the upstream and downstream sides of the electromagnetic valve, the electromagnetic valve fails to come into the intermediate opening degree, which might incur oil hammer.

It is an object of the invention to provide a brake control device in which a stable intermediate opening degree can be achieved.

### Solution to Problem

In one embodiment of the invention, amount of energization for energizing a solenoid of an electromagnetic valve is calculated in accordance with difference between pressures on the upstream and downstream sides of the electromagnetic valve before hydraulic pressure adjustment of a braking force generator is finished. A valve-opening amount of the electromagnetic valve is accordingly controlled to fall within an intermediate opening degree range between the open and closed positions of the valve.

According to the one embodiment of the invention, such a solenoid-energization amount as to enable the intermediate opening degree to be achieved is calculated in accordance with the difference between pressures on the upstream and downstream sides of the electromagnetic valve, which stabilizes the intermediate opening degree.

### BRIEF DESCRIPTION OF DRAWINGS

FIG. 1 is a schematic diagram showing a configuration of a brake control device 1 according to an Embodiment 1, which includes a hydraulic circuit.

FIG. 2 is a flowchart showing a flow of valve-opening amount control processing of a SOL/V IN 25 during wheel cylinder pressure increase.

FIG. 3 is a flowchart showing a flow of calculation processing of a start point current value I1 and an end point current value I2 in a Step S4 of FIG. 2.

FIG. 4 is a flowchart showing a flow of second pressure increase processing in a Step S8 of FIG. 2.

FIG. 5 is a time chart of wheel cylinder pressure Pw and a command current value I* of the SOL/V IN 25 during the wheel cylinder pressure increase according to the Embodiment 1.

FIG. 6 is a time chart of wheel cylinder pressure Pw and a command current value I* of a SOL/V IN 25 during wheel cylinder pressure increase according to an Embodiment 2.

### DESCRIPTION OF EMBODIMENTS

### Embodiment 1

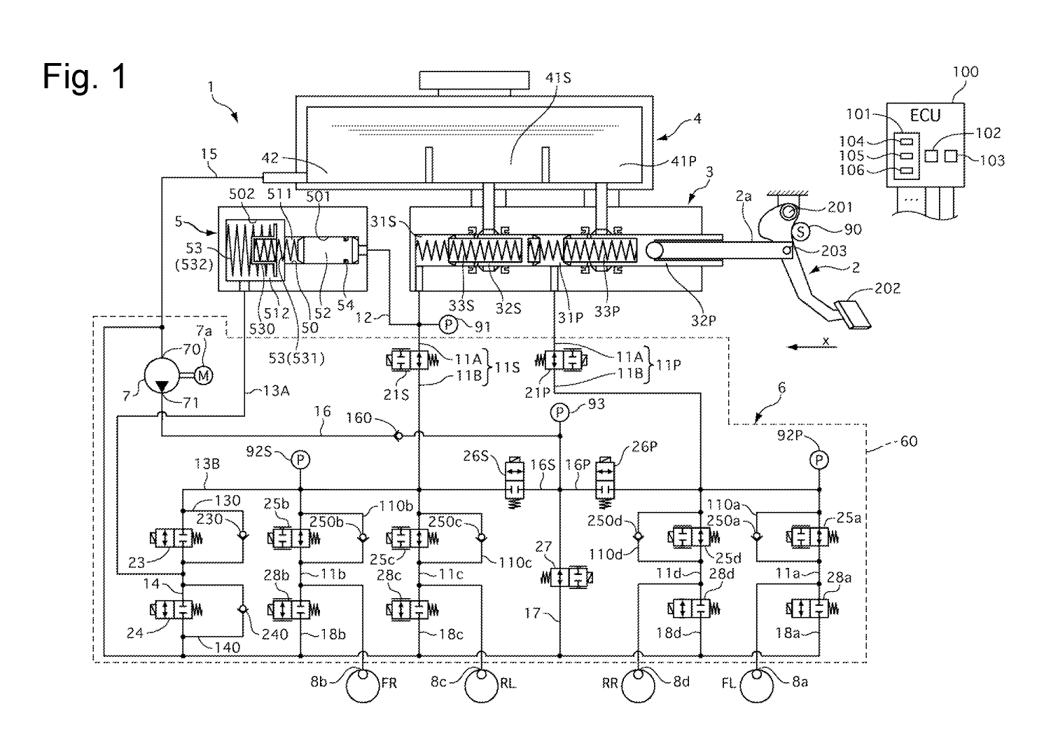

A configuration will be first explained. FIG. 1 shows a schematic configuration of a brake control device 1 according to an Embodiment 1, which includes a hydraulic circuit. The brake control device 1 (hereinafter, referred to as a control device 1) is a hydraulic braking device suitable for electric vehicles. The electric vehicles include hybrid vehicles with motor generators (rotating electrical machines) as well as engines (internal combustion engines), electric vehicles and other vehicles, provided only with motor generators, as motors for driving wheels. The control device 1 may be installed in a vehicle using an engine as the only drive force source. The control device 1 supplies brake fluid to wheel cylinders (braking force generators) 8 respectively provided to wheels FL, FR, RL and RR of a vehicle to generate hydraulic brake pressure (wheel cylinder pressure Pw). This wheel cylinder pressure Pw is used to move and press a friction member against a rotating member located on a wheel side, thereby creating a friction force. The wheels FL, FR, RL and RR are thus imparted with a hydraulic braking force. The wheel cylinders 8 may be wheel cylinders of a drum brake mechanism as well as wheel cylinders of a hydraulic brake caliper used in a disc brake mechanism. The control device 1 has dual-system, or more specifically, P (primary) and S (secondary)-system brake line. The control device 1 has, for example, X-type brake line. The control device 1 may have another type of line, such as a front-rear brake line. Hereinafter, components will be provided with indexes P and S at the end of their reference marks when it is necessary to distinguish between the components corresponding to the primary system and those corresponding to the secondary system.

A brake pedal 2 is a braking member which receives an input of brake operation by operator (driver). The brake member 2 is of a so-called suspension type and is rotatably supported at a proximal end by a shaft 201. At a distal end of the brake pedal 2, there is disposed a pad 202 which is depressed by the driver. One end of a pushrod 2a is rotatably connected by a shaft 203 to the proximal end of the brake pedal 2 between the shaft 201 and the pad 202.

A master cylinder 3 is activated by the driver's operation of the brake pedal 2 (brake operation) to generate a hydraulic brake pressure (master cylinder pressure Pm). The control device 1 is not equipped with a vacuum booster for boosting or amplifying a brake operation force (pedal effort F of the brake pedal 2) by using manifold air pressure generated by the vehicle engine. This downsizes the control device 1. The master cylinder 3 is connected to the brake pedal 2 through the pushrod 2a and supplied with brake fluid from a reservoir tank 4. The reservoir tank 4 is a brake fluid source in which the brake fluid is stored. The reservoir tank 4 is a low-pressure portion which is opened to atmospheric pressure. The reservoir tank 4 has an inner space whose bottom side (lower side in a vertical direction) is sectioned (comparted) by a plurality of partition members with predetermined height into a primary-hydraulic-chamber space 41P, a secondary-hydraulic-chamber space 41S, and a pump-suction space 42. The master cylinder 3 is of a tandem type and includes a primary piston 32P and a secondary piston 32S arranged in tandem, which serve as master cylinder pistons axially displaced in accordance with brake operation. The primary piston 32P is connected to the pushrod 2a. The secondary piston 32S is of a free piston type.

The brake pedal 2 is provided with a stroke sensor 90. The stroke sensor 90 detects a displacement amount of the brake pedal 2 (pedal stroke S). The stroke sensor 90 may instead be placed in the pushrod 2a or in the primary piston 32P to detect the pedal stroke S. The S is a result of multiplying an axial displacement amount (stroke amount) of the pushrod 2a or of the primary piston 32P by a pedal ratio K of the brake pedal. The K is a ratio of the pedal stroke S to the stroke amount of the primary piston 32P and is set at a predetermined value. The K can be calculated, for example, from a ratio of distance between the shaft 201 and the pad 202 to distance between the shaft 201 and the shaft 203.

A stroke simulator 5 is actuated in accordance with the driver's brake operation. The stroke simulator 5 generates the pedal stroke S when the brake fluid which has flown out of the inner space of the master cylinder 3 flows into the stroke simulator 5 in accordance with the driver's brake operation. The brake fluid supplied from the master cylinder 3 displaces a piston 52 of the stroke simulator 5 in the axial direction within a cylinder 50. In this manner, the stroke simulator 5 creates an operation reaction force along with the driver's brake operation.

A hydraulic control unit 6 is a brake control unit which is capable of generating a hydraulic brake pressure independently of the driver's brake operation. An electronic control unit (hydraulic pressure controller, control unit; hereinafter, referred to as an ECU) 100 is a control unit for controlling the actuation of the hydraulic control unit 6. The hydraulic control unit 6 is supplied with the brake fluid from the reservoir tank 4 or the master cylinder 3. The hydraulic control unit 6 is disposed between the wheel cylinders 8 and the master cylinder 3. The hydraulic control unit 6 is capable of supplying the master cylinder pressure Pm or hydraulic control pressure to wheel cylinders 8 individually. The hydraulic control unit 6 includes a motor 7a of a pump 7 and a plurality of control valves (electromagnetic valves 26 and other valves), as hydraulic devices (actuators) for generating the hydraulic control pressure. The pump 7 sucks in the brake fluid from the brake fluid source (reservoir tank 4 or another source) other than the master cylinder 3 and discharges the brake fluid toward the wheel cylinders 8. The pump 7 may comprise, for example, a plunger pump or a gear pump. The pump 7 is commonly used between the two systems and rotationally driven by the electric motor (rotating electrical machine) 7a serving as a shared drive source. The motor 7a may be, for example, a brushed motor. The electromagnetic valves 26 and the other valves are opened/closed in accordance with a control signal to switch the connection of an oil passage 11 and the like, thereby controlling a brake fluid flow.

The hydraulic control unit 6 is capable of pressurizing the wheel cylinders 8 by the hydraulic pressure generated by the pump 7, while the master cylinder 3 and the wheel cylinders 8 are being disconnected. The hydraulic control unit 6 includes hydraulic pressure sensors 91, 92 and 93 for detecting hydraulic pressures at different points, such as discharge pressure of the pump 7, the Pm, etc.

The ECU 100 is entered with information about detected values transmitted from the stroke sensor 90 and the hydraulic pressure sensors 91, 92 and 93, and a traveling condition transmitted from the vehicle side. On the basis of each piece of the information, the ECU 100 conducts information processing according to a stored program. In accordance with a result of the processing, the ECU 100 outputs a command signal to each of the actuators of the hydraulic control unit 6 to control the actuators. More specifically, the ECU 100 controls the opening/closing of the electromagnetic valves 26 and the other valves and further controls a rotating speed of the motor 7a (i.e., a discharge amount of pump 7). Wheel cylinder pressures Pw of the wheels FL, FR, RL and RR are thus controlled, and various brake control operations are consequently carried out. The brake control operations include, for example, boost control, antilock brake control, brake control for controlling vehicle motion, automatic brake control, regenerative braking cooperative control, and other control operations. The boost control generates a hydraulic braking force which is not sufficiently generated by the driver's brake operation force, to thereby assist the brake operation. The antilock brake control prevents skidding (lock tendency) of the wheels FL, FR, RL and RR, which is caused by braking. The ECU 100 is an antilock brake controller configured to implement the antilock brake control. The vehicle motion control is a vehicle behavior stability control (hereinafter, referred to as ESC) for preventing side slipping or the like. The automatic brake control is preceding vehicle following control or the like. The regenerative cooperative brake control controls the Pw in consort with a regenerative brake so that a target deceleration (target braking force) is obtained.

A primary hydraulic pressure chamber 31P is defined between the pistons 32P and 32S of the master cylinder 3. A coil spring 33P is installed in a compressed position within the primary hydraulic pressure chamber 31P. A secondary hydraulic pressure chamber 31S is defined between the piston 32S and an x-axis forward direction end of a cylinder 30. A coil spring 33S is installed in a compressed position within the secondary hydraulic pressure chamber 31S. The first oil passage 11 opens in the hydraulic pressure chambers 31P and 31S. The hydraulic pressure chambers 31P and 31S are connected to the hydraulic control unit 6 and can come into communication with the wheel cylinders 8 through the first oil passage 11.

Depression of the brake pedal 2 by the driver displaces the pistons 32 and thus generates the hydraulic pressures Pm in accordance with a reduction in volume of the hydraulic pressure chambers 31. The hydraulic pressures Pm thus generated in the hydraulic pressure chambers 31P and 31S are substantially equal to each other. In response to the generation of the hydraulic pressures Pm, the brake fluid is supplied from the hydraulic pressure chambers 31 through the first oil passage 11 toward the wheel cylinders 8. The master cylinder 3 is capable of pressurizing the P-system wheel cylinders 8a and 8d through the P-system oil passage (first oil passage 11P) by the Pm generated in the primary hydraulic pressure chamber 31P. The master cylinder 3 is further capable of pressurizing the S-system wheel cylinders 8b and 8c through the S-system oil passage (first oil passage 11S) by the Pm generated in the secondary hydraulic pressure chamber 31S.

The following description explains the configuration of the stroke simulator 5. The stroke simulator 5 includes the cylinder 50, the piston 52, and a spring 53. FIG. 1 shows a cross-section along the axis of the cylinder 50 of the stroke simulator 5. The cylinder 50 is formed into a cylindrical shape and has a circular cylinder-like inner peripheral surface. The cylinder 50 includes a piston housing portion 501 with a relatively small diameter in an x-axis backward direction side, and a spring housing portion 502 with a relatively large diameter in an x-axis forward direction side. A third oil passage 13 (13A) described later normally opens in an inner peripheral surface of the spring housing portion 502. The piston 52 is installed in an inner peripheral side of the piston housing portion 501 so as to be displaceable in the x-axial direction along an inner peripheral surface of the piston housing portion 501. The piston 52 is a separation member (partition wall) which separates the cylinder 50 into at least two chambers (positive pressure chamber 511 and back pressure chamber 512). Within the cylinder 50, the positive pressure chamber 511 is defined on the x-axis backward direction side of the piston 52, and the back pressure chamber 512 on the x-axis forward direction side of the piston 52. The positive pressure chamber 511 is a space enclosed by an x-axis backward direction-side surface of the piston 52 and the inner peripheral surface of the cylinder 50 (piston housing portion 501). A second oil passage 12 normally opens in the positive pressure chamber 511. The back pressure chamber 512 is a space enclosed by an x-axis forward direction-side surface of the piston 52 and the inner peripheral surface of the cylinder 50 (spring housing portion 502, piston housing portion 501). The oil passage 13A normally opens in the back pressure chamber 512.

A piston seal 54 is disposed in an outer periphery of the piston 52 so as to extend in a direction around the axis of the piston 52 (circumferential direction). The piston seal 54 comes into a sliding contact with the inner peripheral surface of the cylinder 50 (piston housing portion 501) to seal a gap between the inner peripheral surface of the piston housing portion 501 and an outer peripheral surface of the piston 52. The piston seal 54 is a separation sealing member which seals a gap between the positive pressure chamber 511 and the back pressure chamber 512 to separate the positive pressure chamber 511 and the back pressure chamber 512 from each other in a liquid-tight manner. The piston seal 54 complements the function of the piston 52 as the separation member. The spring 53 is a coil spring (elastic member) installed in a compressed position within the back pressure chamber 512. The spring 53 constantly biases the piston 52 in the x-axis backward direction. The spring 53 is placed to be deformable in the x-axis direction and capable of generating a reaction force in accordance with a displacement amount (stroke amount) of the piston 52. The spring 53 includes a first spring 531 and a second spring 532. The first spring 531 is smaller than the second spring 532 in diameter, length, and wire diameter. The first spring 531 has a smaller spring constant than the second spring 532. The first and second springs 531 and 532 are arranged in series between the piston 52 and the cylinder 50 (spring housing portion 502) with a retainer 530 intervening between the first and second springs 531 and 532.

The hydraulic circuit of the hydraulic control unit 6 will be explained below. The hydraulic circuit is formed in a housing 60 of the hydraulic control unit 6. Hereinafter, components corresponding to the wheels FL, FR, RL and RR will be respectively provided with indexes a, b, c and d at the end of their reference marks for the purpose of distinguishing the components from one another, when needed. The first oil passage 11 connects the hydraulic pressure chamber 31 of the master cylinder 3 to the wheel cylinders 8. Cutoff valves 21 are normally-open (open when de-energized) electromagnetic valves placed in the first oil passage 11. The first oil passage 11 is separated by the cutoff valves 21 into oil passages 11A located on the master cylinder 3 side and oil passages 11B located on the wheel cylinder 8 side. Solenoid in valves SOL/V IN 25 are normally-open electromagnetic valves placed (in the oil passages 11a, 11b, 11c and 11d) correspondingly to the wheels FL, FR, RL and RR to be located on the wheel cylinder 8 side of the cutoff valves 21 (oil passages 11B) in the first oil passage 11. A bypass oil passage 110 is disposed in parallel with the first oil passage 11, bypassing the SOL/V IN 25. The bypass oil passage 110 is provided with check valves (one-way valves or check valves) 250 which allow the brake fluid to flow only in a direction from the wheel cylinder 8 side toward the master cylinder 3 side.

A suck-in oil passage 15 is an oil passage which connects the reservoir tank 4 (pump-suction space 42) and a suck-in portion 70 of the pump 7 to each other. A discharge oil passage 16 connects a discharge portion 71 of the pump 7 to portions between the cutoff valves 21 and the SOL/V IN 25 in the first oil passages 11B. A check valve 160 is placed in the discharge oil passage 16. The check valve 160 allows the brake fluid to flow only in a direction from the discharge portion 71 of the pump 7 side (upstream side) toward the first oil passage 11 side (downstream side). The check valve 160 is a discharge valve provided to the pump 7. The discharge oil passage 16 includes a P-system oil passage 16P and an S-system oil passage 16S diverging from each other on a downstream side of the check valve 160. The oil passages 16P and 16S are respectively connected to the P-system first oil passage 11P and the S-system first oil passage 11S. The oil passages 16P and 16S function as communication passages which connect the first oil passages 11P and 11S to each other. A communication valve 26P is a normally-closed (closed when de-energized) electromagnetic valve placed in the oil passage 16P. A communication valve 26S is a normally-closed electromagnetic valve placed in the oil passage 16S. The pump 7 is a second hydraulic pressure source which is capable of generating the hydraulic pressure Pw in the wheel cylinders 8 by generating hydraulic pressure in the first oil passage 11 using the brake fluid supplied from the reservoir tank 4. The pump 7 is connected to the wheel cylinders 8a, 8b, 8c and 8d through the communication passages (discharge oil passages 16P and 16S) and the first oil passages 11P and 11S. The pump 7 is capable of pressurizing the wheel cylinders 8 by discharging the brake fluid into the communication passages (discharge oil passages 16P and 16S).

A first pressure decrease oil passage 17 connects a portion of the discharge oil passage 16, which is located between the check valve 160 and the communication valve 26, to the suck-in oil passage 15. A pressure-adjusting valve 27 is a normally-open electromagnetic valve as a first pressure decrease valve that is placed in the first pressure decrease oil passage 17. The pressure-adjusting valve 27 may be of a normally-closed type. A second pressure decrease oil passage 18 connects a portion of the first oil passage 11B, which extends on the wheel cylinder 8 side of the SOL/V IN 25, to the suck-in oil passage 15. Solenoid out valves (pressure decrease valves) SOL/V OUT 28 are normally-closed electromagnetic valves serving as second pressure decrease valves, which are placed in the second pressure decrease oil passage 18. In the present embodiment, the first pressure decrease oil passage (return oil passage) 17 located on the suck-in oil passage 15 side of the pressure-adjusting valve 27 partially coincides with the second pressure decrease oil passage 18 located on the suck-in oil passage 15 side of the SOL/V OUT 28.

A second oil passage 12 is a branched oil passage which diverges from the first oil passage 11B and is connected to the stroke simulator 5. The second oil passage 12, together with the first oil passage 11B, functions as a positive pressure-side oil passage which connects the secondary hydraulic pressure chamber 31S of the master cylinder 3 and the positive pressure chamber 511 of the stroke simulator 5 to each other. The second oil passage 12 may directly connect the secondary hydraulic pressure chamber 31S and the positive pressure chamber 511 to each other without the first oil passage 11B. A third oil passage 13 is a first back pressure-side oil passage which connects the back pressure chamber 512 of the stroke simulator 5 and the first oil passage 11 to each other. More specifically, the third oil passage 13 diverges from a portion of the first oil passage 11S (oil passage 11B), which is located between the cutoff valve 21S and the SOL/V IN 25, and is connected to the back pressure chamber 512. A stroke simulator in valve SS/V IN23 is a normally-closed electromagnetic valve placed in the third oil passage 13. The third oil passage 13 is split by the SS/V IN 23 into the oil passage 13A located on the back pressure chamber 512 side and the oil passage 13B located on the first oil passage 11 side. A bypass oil passage 130 is disposed in parallel with the third oil passage 13, bypassing the SS/V IN 23. The bypass oil passage 130 connects the oil passages 13A and 13B to each other. The bypass oil passage 130 is provided with a check valve 230. The check valve 230 allows the brake fluid to flow from the back pressure chamber 512 side (oil passage 13A) toward the first oil passage 11 side (oil passage 13B), and prevents the brake fluid from flowing in the other direction.

A fourth oil passage 14 is a second back pressure-side oil passage which connects the back pressure chamber 512 of the stroke simulator 5 and the reservoir tank 4 to each other. The fourth oil passage 14 connects a portion (oil passage 13A) of the third oil passage 13, which is located between the back pressure chamber 512 and the SS/V IN 23, to the suck-in oil passage 15 (or the first pressure decrease oil passage 17 located on the suck-in oil passage 15 side of the pressure-adjusting valve 27 or the second pressure decrease oil passage 18 located on the suck-in oil passage 15 side of the SOL/V OUT 28). The fourth oil passage 14 may be connected directly to the back pressure chamber 512 and the reservoir tank 4. A stroke simulator out valve (simulator cut valve) SS/V OUT 24 is a normally-closed electromagnetic valve placed in the fourth oil passage 14. A bypass oil passage 140 is disposed in parallel with the fourth oil passage 14, bypassing the SS/V OUT 24. The bypass oil passage 140 is provided with a check valve 240 which allows the brake fluid to flow from the reservoir tank 4 (suck-in oil passage 15) side toward the third oil passage 13A side, or the back pressure chamber 512 side, and prevents the brake fluid from flowing in the other direction.

The cutoff valve 21, the SOL/V IN 25, the pressure-adjusting valve 27, and the SOL/V OUT 28 are proportional control valves whose opening amount is adjusted in accordance with current supplied to a solenoid. The other valves, namely, the SS/V IN 23, the SS/V OUT 24, and the communication valve 26, are two position valves (on/off valves) switched between open and closed positions in a two-valued manner. Instead of using the other valves mentioned above, it is also possible to use proportional control valves. A hydraulic pressure sensor 91 is disposed in a portion (oil passage 11A) of the first oil passage 11S, which is located between the cutoff valve 21S and the master cylinder 3. The hydraulic pressure sensor 91 detects hydraulic pressure of the above-mentioned portion of the first oil passage 11S (master cylinder pressure Pm and the hydraulic pressure within the positive pressure chamber 511 of the stroke simulator 5). A hydraulic pressure sensor (primary-system pressure sensor, secondary-system pressure sensor) 92 is disposed in a portion of the first oil passage 11, which is located between the cutoff valve 21 and the SOL/V IN 25. The hydraulic pressure sensor 92 detects hydraulic pressure (wheel cylinder pressure Pw) of the above-mentioned portion of the first oil passage 11. A hydraulic pressure sensor 93 is disposed in a portion of the discharge oil passage 16, which is located between the discharge portion 71 (check valve 160) of the pump 7 and the communication valve 26. The hydraulic pressure sensor 93 detects hydraulic pressure (pump discharge pressure) of the above-mentioned portion of the discharge oil passage 16.

A brake system (first oil passage 11) connecting the hydraulic pressure chamber 31 of the master cylinder 3 to the wheel cylinders 8 with the cutoff valve 21 controlled in an open position comprises a first system. The first system uses the pedal effort F to generate the master cylinder pressure Pm and uses the master cylinder pressure Pm to generate the wheel cylinder pressure Pw. The first system is thus capable of achieving pedal effort braking (non-boost control). A brake system (suck-in oil passage 15, discharge oil passage 16, etc.) including the pump 7 and connecting the reservoir tank 4 to the wheel cylinders 8 with the cutoff valve 21 controlled in a closed position comprises a second system. The second system comprises a so-called brake-by-wire system which generates the wheel cylinder pressure Pw using the hydraulic pressure generated by the pump 7. The second system is capable of achieving boost control or the like as brake-by-wire control. During the brake-by-wire control (hereinafter, referred to simply as by-wire control), the stroke simulator 5 creates an operation reaction force along with the driver's brake operation.

The ECU 100 includes a by-wire controller 101, a pedal effort braking portion 102, and a failsafe section 103. The by-wire controller 101 closes the cutoff valve 21 and pressurizes the wheel cylinders 8 using the pump 7 in accordance with the driver's brake operation. More specific details will be discussed below. The by-wire controller 101 includes a braking condition detecting section 104, a target wheel cylinder pressure calculating section 105, and a wheel cylinder pressure controlling section 106. The braking condition detecting section 104 receives a value detected by the stroke sensor 90 and detects the pedal stroke S as an amount of the driver's brake operation. On the basis of the pedal stroke S, the braking condition detecting section 104 further detects whether the brake operation by the driver is taking place (whether the brake pedal 2 is being depressed). It is also possible to provide a pedal effort sensor for detecting the pedal effort F to detect or estimate the brake operation amount on the basis of a value detected by the pedal effort sensor. The brake operation amount may be detected or estimated on the basis of a value detected by the hydraulic pressure sensor 91. In short, the brake operation amount used for control may be other proper valuables than the pedal stroke S.

The target wheel cylinder pressure calculating section 105 calculates a target wheel cylinder pressure Pw*. For example, during the boost control, on the basis of the detected pedal stroke S (brake operation amount), the target wheel cylinder pressure calculating section 105 calculates the target wheel cylinder pressure Pw* which enables an ideal relationship (braking characteristic) between the S and a hydraulic brake pressure required by the driver (vehicle acceleration required by the driver) in accordance with a predetermined boosting ratio. The ideal relationship for calculating the target wheel cylinder pressure Pw* is, for example, predetermined relationship between a pedal stroke S and a wheel cylinder pressure Pw (braking force), which are achieved when a vacuum booster of a regular size is in operation in a brake system.

The wheel cylinder pressure controlling section 106 turns the cutoff valve 21 into the closed position and thus brings the hydraulic control unit 6 into a state where the wheel cylinder pressure Pw (pressurization control) can be generated using the pump 7 (second system). In this state, the wheel cylinder pressure controlling section 106 implements the hydraulic control (for example, boost control) which controls the actuators of the hydraulic control unit 6 to achieve the Pw*. To be more specific, the wheel cylinder pressure controlling section 106 turns the cutoff valve 21 into the closed position, the communication valve 26 into the open position, and the pressure-adjusting valve 27 into the closed position. At the same time, the wheel cylinder pressure controlling section 106 actuates the pump 7. Such control enables desired brake fluid to be sent from the reservoir tank 4 side to the wheel cylinders 8 through the suck-in oil passage 15, the pump 7, the discharge oil passage 16, and the first oil passage 11. The brake fluid discharged by the pump 7 flows through the discharge oil passage 16 and enters the first oil passage 11B. When this brake fluid flows into the wheel cylinders 8, the wheel cylinders 8 are pressurized. The hydraulic pressure generated in the first oil passage 11B by the pump 7 is used to pressurize the wheel cylinders 8. At this time, if the rotating speed of the pump 7 and the opening degree of the pressure-adjusting valve 27 are subjected to feedback control so that a value detected by the hydraulic pressure sensor 92 approaches the Pw*, a desired braking force can be obtained. In other words, the Pw can be adjusted by controlling the opening degree of the pressure-adjusting valve 27 and properly releasing the brake fluid from the discharge oil passage 16 or the first oil passage 11 through the pressure-adjusting valve 27 to the suck-in oil passage 15. In the present embodiment, the wheel cylinder pressure Pw is basically controlled, not by varying the rotating speed of the pump 7 (motor 7a), but by varying the opening degree of the pressure-adjusting valve 27. Since the cutoff valve 21 is turned into the closed position to disconnect the master cylinder 3 side from the wheel cylinders 8 side, it becomes easy to control the wheel cylinder pressure Pw independently of the driver's brake operation.

The SS/V OUT 24 is turned into the open position. This brings the back pressure chamber 512 of the stroke simulator 5 and the suck-in oil passage 15 (reservoir tank 4) side into communication with each other. Consequently, when the brake fluid is discharged from the master cylinder 3 in response to the depression of the brake pedal 2 to enter the positive pressure chamber 511 of the stroke simulator 5, the piston 52 is actuated. The pedal stroke S is then generated. The brake fluid in equal quantity to the brake fluid that enters the positive pressure chamber 511 flows out of the back pressure chamber 512. The brake fluid, which has flown out of the back pressure chamber 512, is discharged toward the suck-in oil passage 15 (reservoir tank 4) side through the third oil passage 13A and the fourth oil passage 14. The fourth oil passage 14 does not necessarily have to be connected to the reservoir tank 4 as long as the fourth oil passage 14 is connected to a low-pressure portion into which the brake fluid can flow. A pressing force applied to the piston 52 by the spring 53 of the stroke simulator 5, the hydraulic pressure of the back pressure chamber 512, and the like creates the operation reaction force (pedal reaction force) which acts on the brake pedal 2. During the by-wire control, therefore, the stroke simulator 5 generates characteristics of the brake pedal 2 (F-S characteristic that is relationship of S with F).

The pedal effort braking section 102 opens the cutoff valve 21 and pressurizes the wheel cylinders 8 by using the master cylinder 3. The pedal effort braking section 102 turns the cutoff valve 21 into the open position, to thereby bring the hydraulic control unit 6 into a state where the wheel cylinder pressure Pw can be generated by the master cylinder pressure Pm (first system), and achieve the pedal effort braking. At this time, the SS/V OUT 24 is turned into the closed position so that the stroke simulator 5 is not actuated by the driver's brake operation. The brake fluid is therefore efficiently supplied from the master cylinder 3 toward the wheel cylinders 8. It is then also possible to prevent a reduction in the wheel cylinder pressure Pw, which occurs due to the driver's pedal effort F. To be more specific, the pedal effort braking section 102 brings all the actuators of the hydraulic control unit 6 into the inactive condition. Alternatively, the SS/V IN 23 may be turned into the open position.

The failsafe section 103 detects the occurrence of an abnormality (defect or failure) in the control device 1 (brake system). The failsafe section 103 detects, for example, a defect of the actuator (pump 7 or motor 7a, pressure-adjusting valve 27 or the like) of the hydraulic control unit 6 on the basis of a signal transmitted from the braking condition detecting section 104 and a signal from each sensor. The failsafe section 103 also detects the occurrence of an abnormality in a power source (battery) equipped in a vehicle, which supplies power to the control device 1, and an abnormality in the ECU 100. When detecting the occurrence of an abnormality during the by-wire control, the failsafe section 103 actuates the pedal effort braking section 102 and switches from the by-wire control to the pedal effort braking. More specifically, the failsafe section 103 brings all the actuators of the hydraulic control unit 6 into the inactive condition and shifts the brake operation to the pedal effort braking. The cutoff valve 21 is a normally-open valve. Since the cutoff valve 21 is open in the event of a power failure, the pedal effort braking can be automatically carried out. The SS/V OUT 24 is a normally-closed valve. Since the SS/V OUT 24 is closed in the event of a power failure, the stroke simulator 5 is automatically brought into the inactive condition. The communication valve 26 is of a normally-closed type. This makes it possible to separate the hydraulic brake pressure systems of both the systems from each other and carry out wheel cylinder pressurization using the pedal effort F separately in each system in the event of a power failure. Failsafe performance can be accordingly improved.

[Valve-Opening Amount Control of The SOL/V IN During Wheel Cylinder Pressure Increase]

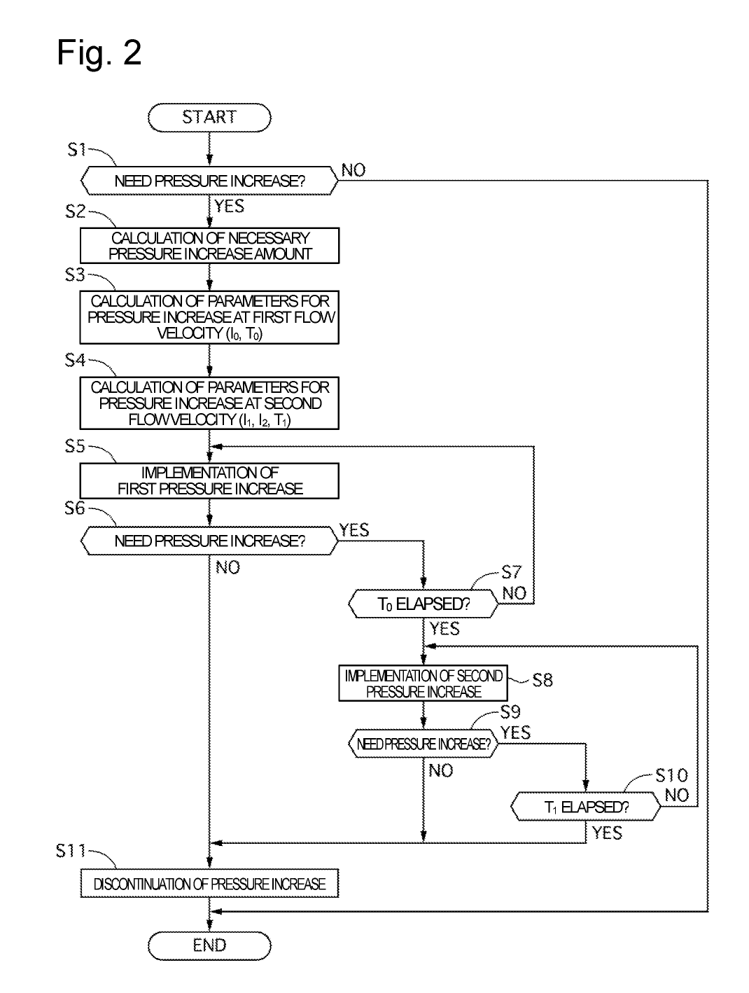

When the ECU determines that it is necessary to control the wheel cylinder pressures to be individual pressures in order to implement the antilock brake control (ABS control) or the like, the ECU 100 conducts the following processing. FIG. 2 is a flowchart showing a flow of valve-opening amount control processing of the SOL/V IN 25 during wheel cylinder pressure increase.

A Step S1 makes a determination whether pressure increase is needed. If the determination is YES, the flow advances to a Step S2. If the determination is NO, the present control processing is terminated. In the above-mentioned step, a comparison is made between the target wheel cylinder pressure Pw* and the wheel cylinder pressure Pw in each of the wheel cylinders 8, and determines that pressure increase is needed if the Pw* is higher than the Pw.

The Step S2 calculates a necessary pressure increase amount (Pw*-Pw).

A Step S3 calculates a full-valve-opening current value I0 and an energization time (first valve opening time) TO for carrying out first pressure increase at high flow velocity, which focuses on quantity of passing fluid. The full-valve-opening current value I0 is a current value corresponding to maximum valve opening amount (first valve opening amount) of the SOL/V IN 25. The energization time TO is calculated on the basis of the necessary pressure increase amount (Pw*-Pw).

A Step S4 calculates a start-point current value I1 and an end-point current value I2 as intermediate current values, and an energization time (second valve opening time) T1 for carrying out second pressure increase at low flow velocity. The intermediate current values are current values corresponding to the intermediate opening degree (second valve opening amount) of the SOL/V IN 25. The start-point current value I1 is a current value corresponding the valve opening amount at the start (initial stage) of the second pressure increase. The end-point current value I2 is a current value corresponding to valve opening amount at the end (last stage) of the second pressure increase. A method of calculating the start-point current value I1 and the end-point current value I2 will be discussed later. The energization time T1 is calculated on the basis of the necessary pressure increase amount (Pw*-Pw), the energization time T0, the start-end current value T1, and the end-point current value I2, thereby preventing deficiency and excess in the pressure increase amount.

A Step S5 conducts the first pressure increase. In the first pressure increase, the full-valve-opening current value I0 is applied as a command current value I* to a solenoid of the SOL/V IN 25.

A Step S6 makes a comparison between the target wheel cylinder pressure Pw* and the actual wheel cylinder pressure Pw, and determines whether pressure increase is needed. If the determination is YES, the flow proceeds to a Step S7. If the determination is NO, the flow proceeds to a Step S11. The actual wheel cylinder pressure Pw is estimated, for example, from the hydraulic pressure detected by the hydraulic pressure sensor 92 and the energization time that has elapsed since the beginning of the first pressure increase.

A Step S7 makes a determination whether the energization time TO has elapsed since the beginning of the first pressure increase. If the determination is YES, the flow advances to a Step S8. If the determination is NO, the flow returns to the Step S5.

The Step S8 conducts the second pressure increase. In the second pressure increase, the intermediate current value is applied as the command current value I1* to the solenoid of the SOL/V IN 25. The second pressure increase will be discussed later in detail.

A Step S9 makes a comparison between the target wheel cylinder pressure Pw* and the actual wheel cylinder pressure Pw, and determines whether pressure increase is needed. If the determination is YES, the flow advances to a Step S10. If the determination is NO, the flow advances to a Step S11. The actual wheel cylinder pressure Pw is estimated, for example, from the hydraulic pressure detected by the hydraulic pressure sensor 92, the energization time that has elapsed since the beginning of the second pressure increase, and the valve opening amount of the SOL/V IN 25.

The Step S10 makes a determination whether the energization time T1 has elapsed since the beginning of the second pressure increase. If the determination is YES, the flow advances to the Step S11. If the determination is NO, the flow returns to the Step S8.

In the Step S11, a full-valve-closing current value Ic for terminating the pressure increase is applied as the command current value I* to the solenoid of the SOL/V IN 25. The full-valve-closing current value Ic is a current value corresponding to the fully closed position of the SOL/V IN 25.

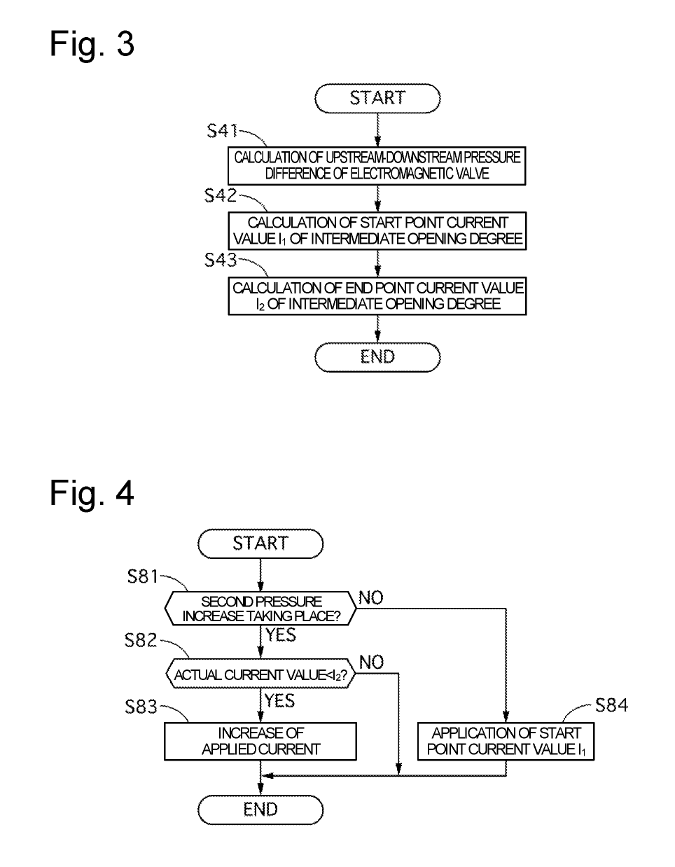

FIG. 3 is a flowchart showing a flow of calculation processing of the start point current I1 and the end point current 12 in the Step S4 of FIG. 2.

A Step S41 calculates upstream-downstream pressure difference (difference between pressures on the upstream and downstream sides) of the SOL/V IN 25. The pressure difference is, for example, difference between the hydraulic pressure detected by the hydraulic pressure sensor 92 and the hydraulic pressure detected by the hydraulic pressure sensor 92 immediately before the SOL/V IN 25 is fully closed. The pressure difference may be an estimated value.

A Step S42 calculates, as the start point current value I1, a current value for shifting the SOL/V IN 25 from the fully open position to an intermediate opening degree, on the basis of the upstream-downstream pressure difference of the SOL/V IN 25, which has been calculated in the Step S41, the necessary pressure increase amount (Pw*-Pw), and a flow velocity, flow rate, temperature, viscosity and other like properties of the brake fluid passing through the SOL/V IN 25. A zone from the full-valve-opening current value IO to the start point current value I1 is a dead band of current, in which the SOL/V IN 25 is constantly in the fully open position.

A Step S43 calculates, as the end point current value I2, a current value for shifting the SOL/V IN 25 in the intermediate opening degree to the fully closed position, on the basis of the upstream-downstream pressure difference of the SOL/V IN 25, which has been calculated in the Step S41, the necessary pressure increase amount (Pw*-Pw), and a flow velocity, flow rate, temperature, viscosity and other like properties of the brake fluid passing through the SOL/V IN 25. The end point current value I2 is a current value between the start point current value I1 and the full-valve-closing current value Ic. The larger the upstream-downstream pressure difference of the SOL/V IN 25 is, the lower the end point current value I2 is. A zone from the end point current value I2 to the full-valve-closing current value Ic is a dead band in which the position of the SOL/V IN 25 does not change from the position at the time point when the SOL/V IN 25 is applied with the end point current value I2.

FIG. 4 is a flowchart showing a flow of the second pressure increase processing in the Step S8 of FIG. 2.

A Step S81 makes a determination whether the second pressure increase is carried out. If the determination is YES, the flow advances to a Step S82. If the determination is NO, the flow advances to a Step S84.

The Step S82 makes a determination whether the actual command current value I* is lower than the end point current value I2. If the determination is YES, the flow advances to a Step S83. If the determination is NO, the present control processing is terminated.

The Step S83 increments and applies the command current value I* to the solenoid of the SOL/V IN 25. More specifically, the command current value I* is a result of adding a micro value Δi to the previous command current value I* in order to increment the command current value I* by degrees.

The Step S84 applies the start point current value I1 as the command current value I* to the solenoid of the SOL/V IN 25.

The foregoing description has discussed the valve opening amount control processing of the SOL/V IN 25 during the wheel cylinder pressure increase. The same processing is applied to the SOL/V OUT 28 when the wheel cylinder pressure is decreased for the antilock brake control or the like.

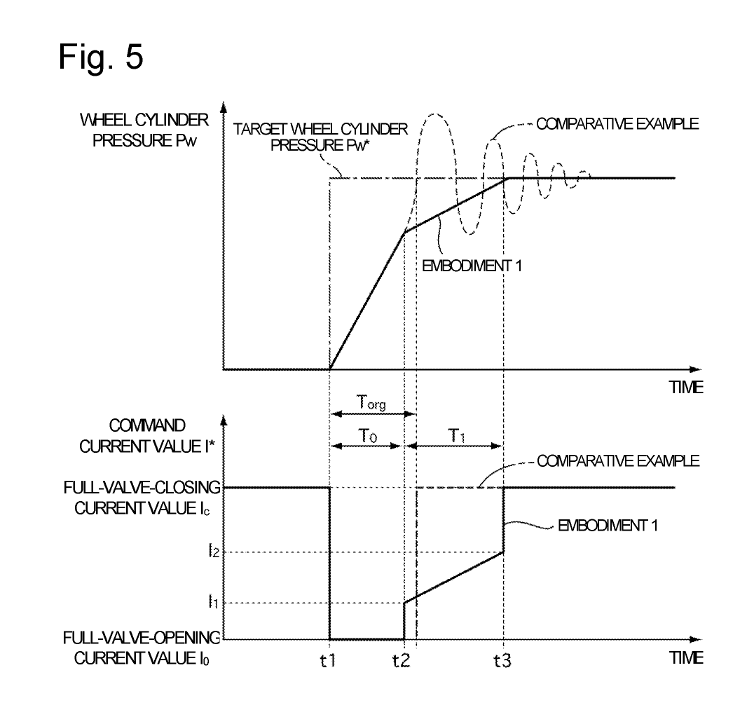

FIG. 5 is a time chart of the wheel cylinder pressure Pw and the command current value I* of the SOL/V IN 25 during the wheel cylinder pressure increase of the Embodiment 1. The time chart is based on the premise that the target wheel cylinder pressure Pw* is constant.

At a Time t1, the target wheel cylinder pressure Pw* rises up instantaneously and becomes higher than the wheel cylinder pressure Pw. The flowchart of FIG. 2 accordingly proceeds in the order of the Step S1, S2, S3, S4 and S5 to start the first pressure increase. The first pressure increase applies the full-valve-opening current value I0 as the command current value I* to the solenoid of the SOL/V IN 25. The SOL/V IN 25 is switched from the fully closed position to the fully open position.

In a zone between the Time t1 and a Time t2, the target wheel cylinder pressure Pw* is higher than the wheel cylinder pressure Pw, and the energization time TO has not elapsed since the beginning of the first pressure increase, so that the first pressure increase is continued in a loop of the Steps S5, S6 and S7. The SOL/V IN 25 is maintained in the fully closed position, which provides highly responsive pressure-rising characteristics of the wheel cylinder pressure Pw.

At the Time t2, the energization time TO has elapsed since the beginning of the first pressure increase. The flow proceeds from the Step S7 to S8, and the second pressure increase is started. At the start of the second pressure increase, the start point current value I1 is applied as the command current value I* to the solenoid of the SOL/V IN 25. The valve opening amount of the SOL/V IN 25 corresponds to the intermediate opening degree between the open position and the closed position.

In a zone between the Time t2 and a Time t3, the target wheel cylinder pressure Pw* is higher than the wheel cylinder pressure Pw, and the energization time T1 has not elapsed since the beginning of the second pressure increase, so that the second pressure increase is continued in a loop of the Steps S8, S9 and S10. During the second pressure increase, the command current value I* is incremented by degrees from the start point current value I1 to the end point current value I2, so that the SOL/V IN 25 is maintained in the intermediate opening degree.

At the Time t3, the energization time T1 has elapsed since the beginning of the second pressure increase. The flow proceeds from the Step S10 to S11, and the full-valve-closing current value Ic is applied as the command current value I* to the solenoid of the SOL/V IN 25. The SOL/V IN 25 is fully closed.

[Prevention of Oil Hammer by Stable Intermediate Opening]

FIG. 5 includes dashed lines showing a time chart of a comparative example of the embodiment, in which the command current value I* is switched from the full-valve-opening current value I0 to the full-valve-closing current value I0. In the comparative example, oil hammer occurs, which becomes a factor for vibrations and noises, as a result of a rapid change in flow velocity of the brake fluid, which is caused when the electromagnetic valve is closed. A well-known technology of preventing the oil hammer with an inexpensive structure is to maintain the electromagnetic valve temporarily in the intermediate opening degree when the electromagnetic valve is intended to be closed. According to the conventional art, however, the current applied to the solenoid has a constant value when the valve is intended to be maintained in the intermediately open position, so that there is imbalance between an electromagnetic force generated when current is applied and a force generated by the upstream-downstream pressure difference of the electromagnetic valve. This enables the intermediate opening degree to be achieved. Even if the upstream-downstream pressure difference is constant, there is a possibility that, depending on an individual variability of electromagnetic valves, the intermediate opening degree cannot be achieved by the current value which is applied in order to achieve the intermediate opening degree.

To avoid the above possibility, the control system 1 of the Embodiment 1 calculates, from the upstream-downstream pressure difference of the SOL/V IN 25 and the like, the start point current value I1 required for the SOL/V IN 25 to shift from the fully open position to the intermediate opening, and the end point current I2 required for the SOL/V IN 25 to shift from the intermediate opening degree to the fully closed position. In the process (second pressure increase process) of shifting from the fully open position of the SOL/V IN 25, which is obtained by applying the full-valve-opening current value I0, to the fully closed position of the SOL/V IN 25, which is obtained by applying the full-valve-closing current value Ic, a constant time (T1) is spent to change a current band between the start point current I1 and the end point current I2, to thereby varying the flow rate of the brake fluid through the intermediate opening gradually. Since the intermediate current value which makes it possible to establish an intermediate opening zone is calculated on the basis of the upstream-downstream pressure difference of the SOL/V IN 25, it is possible to obtain the stable intermediate opening, regardless of the upstream-downstream pressure difference. It is therefore possible to prevent the occurrence of oil hammer during the wheel cylinder pressure increase. Furthermore, in the second pressure increase process, the command current value I* is gradually incremented, and the opening degree of the SOL/V IN 25 is gradually decreased. Consequently, the intermediate opening degree can be more reliably achieved against the upstream-downstream pressure difference, which makes it possible to prevent the occurrence of oil hammer with more certainty. In the second pressure increase process, moreover, the increment gradient of the command current value I* becomes gentle as the upstream-downstream pressure difference increases. The occurrence of oil hammer can be therefore effectively prevented by soft landing. The Embodiment 1 shows an example in which the SOL/V IN 25 is operated during the wheel cylinder pressure increase. However, the same advantageous effects can be obtained if the SOL/V OUT 28 is operated during the wheel cylinder pressure decrease.

The Embodiment 1 provides the following advantageous effects.

(1) There are provided the SOL/V IN 25 for adjusting the quantity of the brake fluid supplied to the wheel cylinders 8 provided to the wheels FL, FR, RL and RR to increase/decrease the hydraulic pressures of the wheel cylinders 8; and the ECU 100 configured to turn the SOL/V IN 25 into the open position at the start of the adjustment of the hydraulic pressures of the wheel cylinders 8, close the SOL/V IN 25 at the end of the adjustment of the hydraulic pressures, calculate the amount of energization for energizing the solenoid of the SOL/V IN 25 in accordance with the upstream-downstream pressure difference of the SOL/V IN 25 before the end of the adjustment of the hydraulic pressures, and control the valve opening amount of the SOL/V IN 25 so that the valve opening amount falls within the intermediate opening range between the open position and the closed position.

Since the energization amount which makes it possible to establish the intermediate opening zone to be materialized is calculated in accordance with the upstream-downstream pressure difference of the SOL/V IN 25, stable intermediate opening degree can be achieved, which prevents the occurrence of oil hammer.

(2) The ECU 100 conducts pressure increase as hydraulic pressure adjustment. The oil hammer is then prevented from occurring during the wheel cylinder pressure increase.

(3) The ECU 100 controls the valve opening amount of the SOL/V IN 25 on the basis of the first valve opening amount and the energization time TO at the start of the pressure increase of the SOL/V IN 25, the second valve opening amount smaller than the first valve opening amount, and the energization time T1.

The control of the valve opening amounts and the energization times (valve opening times) eliminates the need for the hydraulic pressure sensors of the wheels, and thus simplifies the control and the configuration.

(4) The ECU 100 calculates the first valve opening amount, the second valve opening amount, and the energization times T0 and T1 on the basis of the necessary pressure increase amount (Pw*-Pw).

The calculation of the valve opening amounts and the energization times (valve opening times) based on the necessary pressure increase amount makes it possible to prevent the deficiency and excess in the pressure increase amount.

(5) The first valve opening amount is the maximum valve opening amount of the SOL/V IN 25.

It is therefore possible to obtain the highly responsive pressure-rising characteristics of the wheel cylinder pressure Pw.

(6) The second valve opening amount has such a hydraulic pressure gradient that the valve opening amount in the last stage is smaller than the valve opening amount in the initial stage. The hydraulic pressure gradient becomes gentle as the upstream-downstream pressure difference of the SOL/V IN 25 increases.

The occurrence of the oil hammer is effectively prevented by the soft landing which reduces fluctuation of the flow rate as the upstream-downstream pressure difference increases.

(7) The first valve opening amount is switched to the second valve opening amount instantaneously.

It is then possible to prevent a deterioration in responsiveness by immediately switching from the first valve opening amount to the second valve opening amount.

(9) The ECU 100 is the antilock brake controller configured to implement the antilock brake control.

The oil hammer is therefore prevented from occurring during the wheel cylinder pressure increase in the antilock brake control.

(10) The ECU 100 conducts pressure decrease as hydraulic pressure adjustment. The oil hammer is therefore prevented from occurring during the wheel cylinder pressure decrease.

(11) There are provided the SOL/V IN 25 disposed in the oil passage 13 connected to the wheel cylinders 8 provided to the wheels FL, FR, RL and RR; and the ECU 100 configured to turn the SOL/V IN 25 into the open position at the start of the increase of the wheel cylinder hydraulic pressure, close the SOL/V IN 25 at the end of the pressure increase, control the valve opening amount of the SOL/V IN 25, before the end of the pressure increase, to achieve an intermediate opening degree which is smaller than an intermediate opening degree at the start of the pressure increase, and determine the valve opening amount while the intermediate opening degree is maintained or the command current value for achieving the intermediate opening degree on the basis of the upstream-downstream pressure difference of the SOL/V IN 25, the flow velocity of the brake fluid passing through the SOL/V IN 25, the flow rate of the brake fluid passing through the SOL/V IN 25, and the temperature or viscosity of the brake fluid passing through the SOL/V IN 25.

Since the valve opening amount that enables the intermediate opening degree to be achieved is determined on the basis of the upstream-downstream pressure difference of the SOL/V IN 25, the flow velocity, flow rate, temperature, and viscosity of the brake fluid passing through the SOL/V IN 25, a stable intermediate opening degree can be achieved, which prevents the oil hammer from occurring during the wheel cylinder pressure increase.

(16) There is provided the brake control device comprising the oil passage 13 connected to the wheel cylinders 8 formed in the housing 60, the SOL/V IN 25 provided in the housing 60 to open and close the oil passage 13, and the ECU 100 configured to control the valve opening amount of the SOL/V IN 25 to implement the antilock brake control which increases/decreases the wheel cylinder hydraulic pressure. The ECU 100 turns the SOL/V IN 25 into the open position at the start of the increase of the wheel cylinder hydraulic pressure in the antilock brake control, increases the wheel cylinder hydraulic pressure, closes the SOL/V IN 25 at the end of the pressure increase to maintain or decrease the wheel cylinder hydraulic pressure, and before the end of the pressure increase, implements gradual pressure increase in which the valve opening amount of the SOL/V IN 25 corresponds to the intermediate opening degree which is smaller than the intermediate opening degree at the start of the pressure increase, the intermediate opening degree being calculated on the basis of the upstream-downstream pressure difference of the SOL/V IN 25.

Since the pressure is gradually increased to obtain the intermediate opening degree based on the upstream-downstream pressure difference of the SOL/V IN 25 before the end of the pressure increase, a stable intermediate opening degree can be achieved, which prevents the oil hammer from occurring during the wheel cylinder pressure increase in the antilock brake control.

### Embodiment 2

An Embodiment 2 will be now described. The Embodiment 2 is similar to the Embodiment 1 in basic configuration, and the description will only explain differences from the Embodiment 1. In the Step S8 of FIG. 2 according to the Embodiment 2, at the start of second pressure increase, a command current value I* of a SOL/V IN 25 is switched in a stepwise manner from a full-valve-closing current value I0 to a start point current value I1 which is an intermediate current value. To be more specific, during a time period before the command current value i* reaches the start point current value I1, a result of adding a predetermined value ΔI to a previous command current value I* is used as the command current value I*. Operations after the command current value i* reaches the start point current value I1 are the same as those of the Embodiment 1.

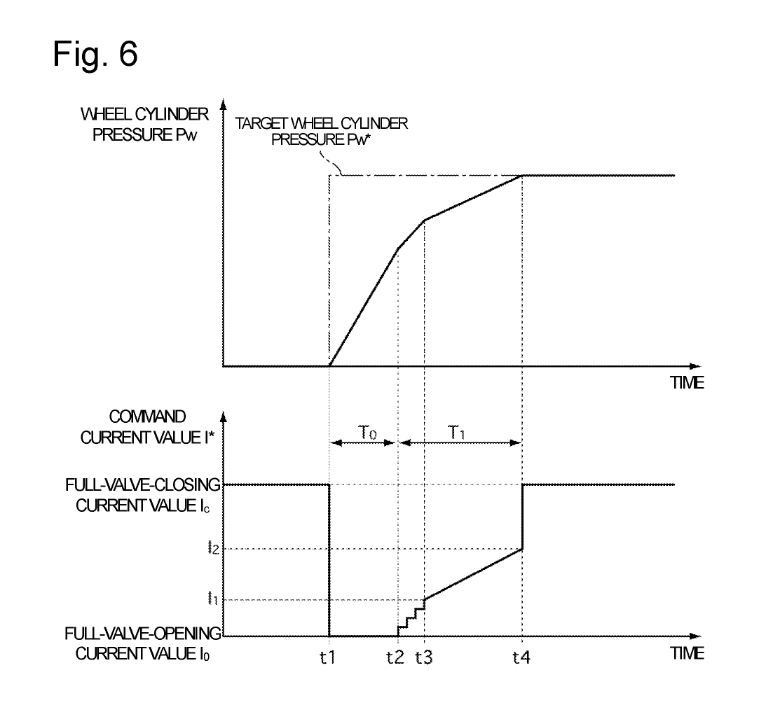

FIG. 6 is a time chart of the wheel cylinder pressure Pw and the command current value I* of the SOL/V IN 25 during wheel cylinder pressure increase according to the Embodiment 2.

A zone between Times t1 and t2 is the same as that between the Times t1 and t2 in FIG. 5.

At the time t2, an energization time TO has elapsed since the beginning of first pressure increase, so that second pressure increase is started.

In a zone between the Time t2 and a Time t3, the command current value I* is switched in a stepwise manner from the full-valve-closing current value I0 to the start point current value I1 which is the intermediate current value. Valve opening amount of the SOL/V IN 25 increases in a stepwise manner, which makes it possible to make a fluctuation in flow rate smaller, as compared to a case in which the switchover of the command current value I* takes place instantaneously. This further prevents oil hammer from occurring.

At the Time t3, the command current value I* reaches the start point current value I1.

A zone between the Time t3 and a Time t4 is the same as the zone between the Times t2 and t3 in FIG. 5.

The Embodiment 2 provides the following advantageous effects.

(8) The switchover from a first valve opening amount to a second valve opening amount takes place in a stepwise manner.

When the first valve opening amount is switched to the second valve opening amount, the fluctuation of the flow rate can be reduced, which further prevents the occurrence of oil hammer.

The invention may be configured as below.

(12) The brake control device in which:

the hydraulic control portion controls the electromagnetic valve on the basis of the first valve opening amount and first valve opening time at the start of the pressure increase of the electromagnetic valve, and the intermediate opening degree is achieved by controlling the electromagnetic valve on the basis of the second valve opening amount smaller than the first valve opening amount, and second valve opening time.

The control of the valve opening amounts and the valve opening times eliminates the need for the hydraulic pressure sensors of the wheels, and thus simplifies the control and the configuration.

(13) The brake control device in which:

the hydraulic control portion calculates the valve opening amount and the valve opening time on the basis of the necessary pressure increase amount.

Since the valve opening amount and the valve opening time are calculated on the basis of the necessary pressure increase amount, the deficiency and excess in the pressure increase amount can be prevented.

(14) The brake control device in which:

the intermediate opening degree has a hydraulic pressure gradient so that the valve opening amount in the last stage is smaller than the valve opening amount in the initial stage. The hydraulic pressure gradient becomes gentle as the upstream-downstream pressure difference of the SOL/V IN 25 increases.

Because of the soft landing which reduces fluctuation of the flow rate as the upstream-downstream pressure difference increases, the occurrence of the oil hammer is effectively prevented.

(15) The brake control device in which:

the switchover from the first valve opening amount to the second valve opening amount takes place instantaneously.

Since the first valve opening amount is immediately switched to the second valve opening amount, it is possible to prevent a reduction in responsiveness.

(17) The brake control device in which:

the control unit controls the electromagnetic valve on the basis of the first valve opening amount and the first valve opening time at the start of the pressure increase of the electromagnetic valve, and the intermediate opening degree is achieved by controlling the electromagnetic valve on the basis of the second valve opening amount smaller than the first valve opening amount, and the second valve opening time.

The control of the valve opening amounts and the valve opening times eliminates the need for the hydraulic pressure sensors of the wheels, and thus simplifies the control and the configuration.

(18) The brake control device in which:

the control unit calculates the valve opening amount and the valve opening time on the basis of the necessary pressure increase amount.

The calculation of the valve opening amount and the valve opening time based on the necessary pressure increase amount prevents the deficiency and excess in the pressure increase amount.

The foregoing descriptions are related only to several embodiments of the invention. It should be easily understood by a person skilled in the art that the embodiments illustrated above may be modified or improved in various ways without substantial deviation from the new teachings and advantages of the invention. It is therefore intended that any embodiments added with such modification or improvement are included in the technical scope of the invention. The embodiments may be combined in any way.

The present application claims priority under Japanese Patent Application No. 2015-207111 filed on Oct. 21, 2015. The entire disclosure of Japanese Patent Application No. 2015-207111 filed on Oct. 21, 2015, including the description, claims, drawings and abstract, is incorporated herein by reference in its entirety.

### REFERENCE SIGNS LIST

FL, FR, RL, RR Wheel

1 Brake control device

8 Wheel cylinder (braking force generator)

25 Solenoid in valve (electromagnetic valve)

28 Solenoid out valve (electromagnetic valve)

100 Electronic control unit (hydraulic pressure controller, antilock brake controller)

1. A brake control device comprising:
an electromagnetic valve for adjusting quantity of brake fluid supplied to a braking force generator provided to a wheel and increasing/decreasing hydraulic pressure of the braking force generator; and
a hydraulic pressure controller configured to control the electromagnetic valve into a valve-opening direction at the start of hydraulic pressure adjustment of the braking force generator, and close the electromagnetic valve at the end of the hydraulic pressure adjustment,
the hydraulic pressure controller being configured to calculate amount of energization for energizing a solenoid of the electromagnetic valve in accordance with upstream-downstream pressure difference of the electromagnetic valve before the end of the hydraulic pressure adjustment, and control valve opening amount of the electromagnetic valve so that the valve opening amount falls within an intermediate opening range between open and closed positions of the electromagnetic valve.

2. The brake control device of claim 1, wherein
the hydraulic pressure controller conducts pressure increase as the hydraulic pressure adjustment.

3. The brake control device of claim 2, wherein
the hydraulic pressure controller controls the valve opening amount of the electromagnetic valve on the basis of first valve opening amount and first valve opening time of the electromagnetic valve, second valve opening amount of the electromagnetic valve, which is smaller than the first valve opening amount, and second valve opening time of the electromagnetic valve at the start of pressure increase.

4. The brake control device of claim 3, wherein
the hydraulic pressure controller calculates the valve opening amount and the valve opening time on the basis of necessary pressure increase amount.

5. The brake control device of claim 4, wherein
the first valve opening amount is maximum valve opening amount of the electromagnetic valve.

6. The brake control device of claim 3, wherein
the second valve opening amount has a hydraulic pressure gradient so that the valve opening amount in a last stage is smaller than the valve opening amount in an initial stage, and the hydraulic pressure gradient becomes gentle as the upstream-downstream pressure difference increases.

7. The brake control device of claim 3, wherein
the first valve opening amount is switched to the second valve opening amount instantaneously.

8. The brake control device of claim 3, wherein
the first valve opening amount is switched to the second valve opening amount in a stepwise manner.

9. The brake control device of claim 1, wherein
the hydraulic pressure controller is an antilock brake controller configured to implement antilock brake control.

10. The brake control device of claim 1, wherein
the hydraulic pressure controller conducts pressure decrease as the hydraulic pressure adjustment.

11. A brake control device comprising:
an electromagnetic valve disposed in an oil passage connected to a wheel cylinder provided to a wheel; and
a hydraulic pressure controller configured to control the electromagnetic valve into a valve-opening direction at the start of increase of the wheel cylinder hydraulic pressure, close the electromagnetic valve at the end of the pressure increase, control valve opening amount of the electromagnetic valve, before the end of the pressure increase, to achieve an intermediate opening degree which is smaller than an intermediate opening degree at the start of the pressure increase, and determine valve opening amount corresponding to the intermediate opening degree or a command current value for achieving the intermediate opening degree on the basis of at least one of upstream-downstream pressure difference of the electromagnetic valve, a flow velocity of brake fluid passing through the electromagnetic valve, a flow rate of the brake fluid passing through the electromagnetic valve, and temperature or viscosity of the brake fluid passing through the electromagnetic valve.

12. The brake control device of claim 11, wherein
the hydraulic pressure controller controls the electromagnetic valve on the basis of first valve opening amount and first valve opening time at the start of pressure increase of the electromagnetic valve, and the intermediate opening degree is achieved by controlling the electromagnetic valve on the basis of second valve opening amount smaller than the first valve opening amount, and second valve opening time.

13. The brake control device of claim 12, wherein
the hydraulic pressure controller calculates the valve opening amount and the valve opening time on the basis of necessary pressure increase amount.

14. The brake control device of claim 13, wherein
the intermediate opening degree has a hydraulic pressure gradient so that the valve opening amount in a last stage is smaller than the valve opening amount in an initial stage; and the hydraulic pressure gradient becomes gentle as the upstream-downstream pressure difference increases.

15. The brake control device of claim 14, wherein
the first valve opening amount is switched to the second valve opening amount instantaneously.

16. A brake control device comprising:
an oil passage connected to a wheel cylinder formed in a housing;
an electromagnetic valve provided in the housing to open and close the oil passage; and
a control unit configured to control valve opening amount of the electromagnetic valve to implement antilock brake control for increasing/decreasing the wheel cylinder hydraulic pressure, wherein
the control unit controls the electromagnetic valve into a valve-opening direction at the start of increase of the wheel cylinder hydraulic pressure in the antilock brake control, increases the wheel cylinder hydraulic pressure, closes the electromagnetic valve at the end of the pressure increase to maintain or decrease the wheel cylinder hydraulic pressure, and before the end of the pressure increase, implements gradual pressure increase in which the valve opening amount of the electromagnetic valve corresponds to an intermediate opening degree which is smaller than the intermediate opening degree at the start of the pressure increase, the intermediate opening degree being calculated on the basis of upstream-downstream pressure difference of the electromagnetic valve.

17. The brake control device of claim 16, wherein
the control unit controls the electromagnetic valve on the basis of first valve opening amount and first valve opening time at the start of pressure increase of the electromagnetic valve, and the intermediate opening degree is achieved by controlling the electromagnetic valve on the basis of second valve opening amount smaller than the first valve opening amount, and second valve opening amount.

18. The brake control device of claim 17, wherein
the control unit calculates the valve opening amount and the valve opening time on the basis of necessary pressure increase amount.
